(19) United States
(12) Patent Application Publication
(10) Pub. No.: US 2022/0248711 A1
(43) Pub. Date: Aug. 11, 2022

(54) MATERIALS AND METHODS FOR PRODUCTION OF PLANT-BASED MEAT REPLACEMENT FOOD PRODUCTS

(71) Applicant: Hooray Foods, Inc., San Francisco, CA (US)

(72) Inventors: Srinivas Artham, San Francisco, CA (US); Patrick Dziura, San Francisco, CA (US)

(21) Appl. No.: 17/585,461

(22) Filed: Jan. 26, 2022

Related U.S. Application Data
(60) Provisional application No. 63/142,252, filed on Jan. 27, 2021.

(51) Int. Cl. A23J 3/22; A21D 10/00; A21B 3/13; A21D 13/06

(52) U.S. Cl. CPC A23J 3/227; A21D 13/06; A21B 3/13; A21D 10/002

(57) ABSTRACT

Methods for preparation of plant-based meat replacement food products such as vegan bacon are provided. The methods include the combination of plant-based components such as flour, starch, and water, in molds designed to mimic traditional meat cuts. Meat replacement food products prepared by the methods are also described.

### CROSS-REFERENCES TO RELATED APPLICATIONS

The present application claims priority to U.S. Provisional Pat. Appl. No. 63/142,252, filed on Jan. 27, 2021, which application is incorporated herein by reference in its entirety.

### BACKGROUND OF THE INVENTION

Animal agriculture is the second largest source of greenhouse gas emissions and, in the United States, only cattle produce more greenhouse gas emissions than pigs. Currently there are over 70 million pigs living on U.S. farms today for food production. Raising pigs for food results in greenhouse gas emissions and water-polluting waste runoff and—in some instances—results in animal mistreatment. Although several plant-based substitutes for foods such as bacon and other meats have been developed, there are few substitutes that sufficiently replicate naturally-occurring meat so as to substantively reduce the demand for the meat-based foods.

### BRIEF SUMMARY OF THE INVENTION

Provided herein are methods for preparing a plant-based meat replacement food product. The methods include:
forming a first mixture comprising a flour, a starch, an oil, and water;
forming a second mixture comprising a flour, a starch, an oil, water, and a coloring agent;
combining the first mixture and the second mixture in a mold; and
par-cooking the first mixture and the second mixture in the mold, thereby forming the plant-based meat replacement food product.

In some embodiments, the methods further include forming a third mixture comprising a flour, a starch, an oil, water, and a coloring agent, and combining the third mixture with the first mixture and the second mixture in the mold. The amount and/or type of coloring agent in the second and third mixtures may be varied (e.g., to provide red and pink-colored regions in the food product).

Also provided herein are molds for the preparation of plant-based meat replacement food products. The molds include baking wells configured to provide par-cooked food products with appetizing shapes resembling traditional meat-based foods.

Also provided herein are plant-based meat replacement food products, including vegan bacon and other sliced meat replacements, prepared according to the methods of the disclosure.

### BRIEF DESCRIPTION OF THE DRAWINGS

FIG. 1 shows a view of a bacon-shaped mold according to the present disclosure.

FIG. 2 shows the top and bottom of a bacon-shaped mold according to the present disclosure.

FIG. 3 shows the configuration of baking wells in a bacon-shaped mold according to the present disclosure.

FIG. 4 shows the disposition of mold features so as to resemble naturally occurring contours of cut meat.

FIG. 5 shows the filling of bacon-shaped baking wells in a mold according to the present disclosure.

FIG. 6 shows the final cooking of a par-cooked, plant-based bacon product prior to consumption.

### DETAILED DESCRIPTION OF THE INVENTION

The present invention is based on processes and materials that have been developed for the preparation of plant-based food substitutes with appearance, taste, and cooking properties that are exceptionally true to the characteristics of traditional meat-based foods. This fidelity to traditional meat products arises, in part, from the combination of component mixtures in molds having features that mimic the contours of cut meats.

### I. EMBODIMENTS OF THE DISCLOSURE

Provided herein are methods for preparing a plant-based meat replacement food product. The methods include:
forming a first mixture comprising a flour, a starch, an oil, and water;
forming a second mixture comprising a flour, a starch, an oil, water, and a coloring agent;
combining the first mixture and the second mixture in a mold; and
par-cooking the first mixture and the second mixture in the mold, thereby forming the plant-based meat replacement food product. Additional mixtures (e.g., containing varying amounts of coloring agent) may also be combined with the first and second mixtures in the mold.

### Molds for Preparation of Plant-Based Food Products

The methods provided herein can be used for the preparation of plant-based products for replacement of various meats, including various charcuterie and deli meats. Molds employed in the method may be shaped, for example, to resemble meat slices, cuts, and the like. The mold may be used for shaping the plant-based meat replacement food product in the form of a sliced meat, examples of which include, but are not limited to, sliced bacon, pork belly, pepperoni, pancetta, prosciutto, salami, mortadella, speck, and cold cuts such as pastrami, ham, roast beef, and the like.

In some embodiments, the mold is shaped to resemble a sliced meat. The mold may be, for example, a bacon-shaped mold or a pork belly-shaped mold. The mold can contain one or more baking wells, each of which is contoured to resemble the organic shape of the food that is to be substituted with the plant-based product. The mold can contain any number of baking wells, which may vary depending on factors such as intended batch size and the scale of the manufacturing equipment (e.g., ovens) used for forming and cooking the product. A single mold may contain, for example, a few baking wells ranging to several dozen baking wells. In some embodiments, each of the plurality of baking wells is shaped differently from the other baking wells. Alternatively, the wells may be substantially similar or identical in shape. The wells may be cast in mold materials such as stainless steel, aluminum, or an elastomer such as a silicone.

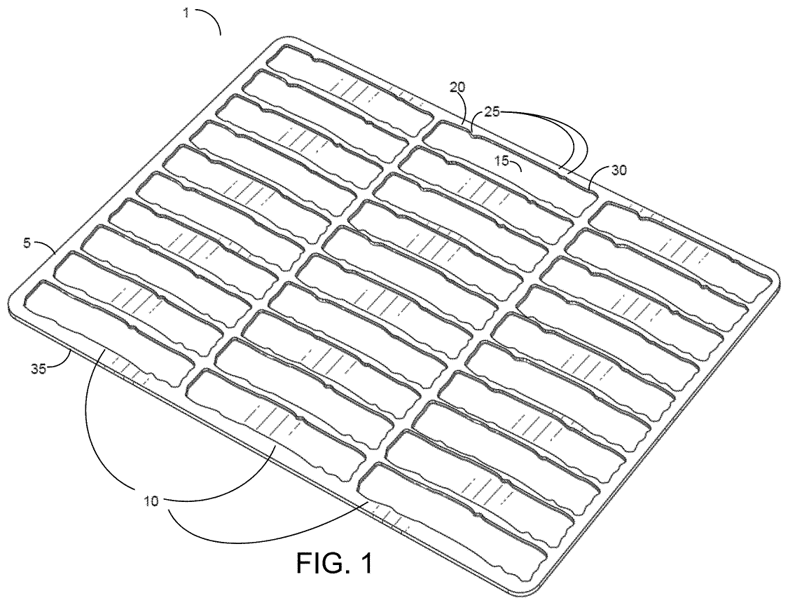

In some embodiments, each of the plurality of baking wells has a bacon strip shape. As shown in FIG. 1, for example, a bacon-shaped mold (1) may include:
a top surface (5) comprising a plurality of baking wells (10),
wherein each baking well comprises:
a floor (15) having a periphery (20) comprising a plurality of shaped features (25), and
walls (30) extending from the top surface of the mold (5) to the floor (15) of the baking well, wherein the walls meet the floor along the periphery of the floor; and
a bottom surface (35).

Depending on the desired shape of the final product, baking wells may be rounded, squared, or various irregular shapes. Strip-shaped baking wells are typically oblong, where the length of a given well is greater than the width of the well. In some embodiments, the average length of each baking well ranges from about two times the average width of the baking well to about ten time the average width of the baking well. In some embodiments, the average length of the baking wells is in the range of 6 inches to 9 inches while the average width of the baking wells is in the range of 1 inch to 4 inches. In some embodiments, the average length of the baking wells is around 8 inches (e.g., 8.05 inches) and the average width of the baking wells is around 1.5 inches (e.g., 1.48 inches).

The strip-shaped baking wells are typically shallow, so as to resemble a thin slice of bacon or other meat. In some embodiments, the depth of the baking well ranges from 0.025 times the average width of the baking well to about 0.25 times the average width of the baking well. In some embodiments, the depth of the baking wells is in the range of 0.05 inches to 0.25 inches while the average width of the baking wells is in the range of 1 inch to 4 inches. In some embodiments, the depth of the baking wells is around 0.15 inches (e.g., 0.13 inches). In some embodiments, the depth of the baking wells is around 0.06 inches (e.g., 0.0625 inches).

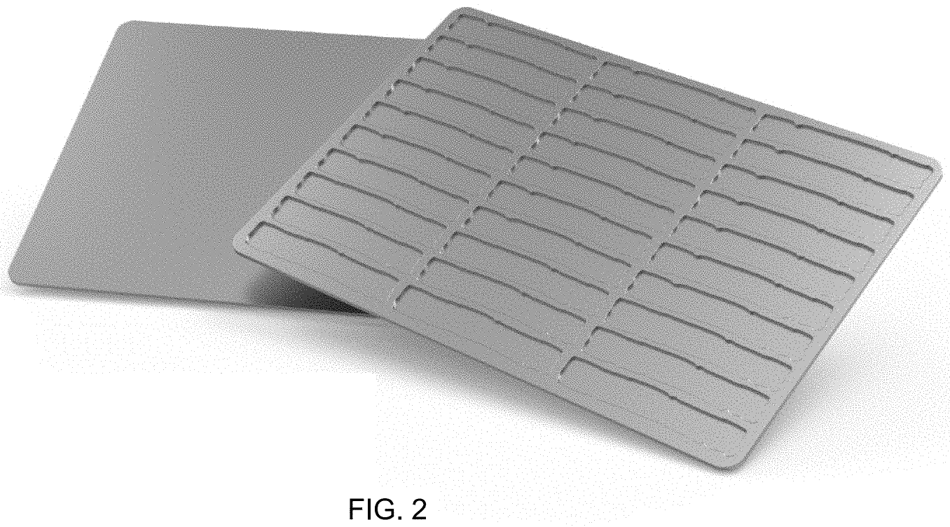

The baking wells are set into the top surface (5) of the mold, but they do not typically extend through the entire thickness of the mold so as to meet the bottom surface (35). In some embodiments, the depth of each baking well ranges from 0.25 times the thickness of the mold to about 0.75 times the thickness of the mold. In some embodiments, the depth of the baking wells is in the range of is in the range of 0.05 inches to 0.25 inches while the thickness of the mold is in the range of 0.15 inches to 0.5 inches. In some embodiments, the depth of the baking wells is around 0.15 inches (e.g., 0.13 inches) and the thickness of the mold is around 0.25 inches. When the wells are shallower than the mold is thick, as shown in FIG. 2, the back of the mold is characterized by a smooth, flat black that facilitates cleaning and storage.

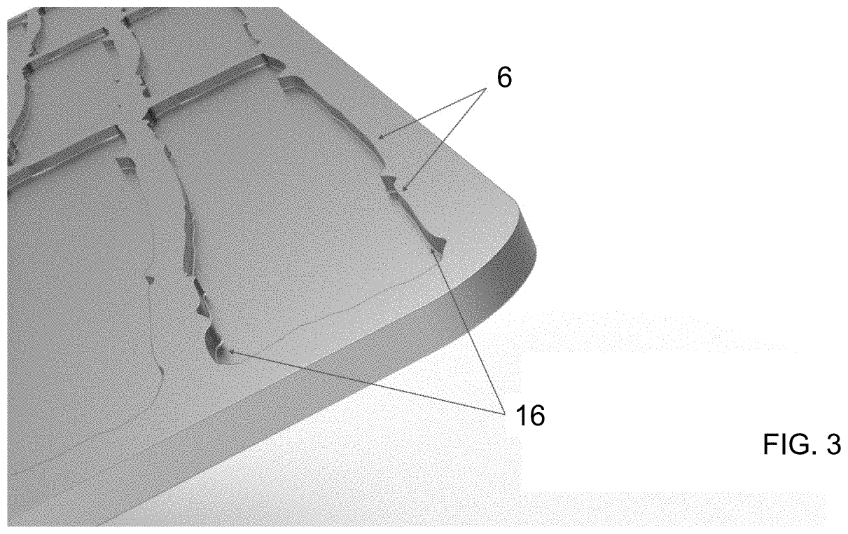

The floor and walls of each baking well can be designed to improve the handling of the plant-based food product during manufacturing and to provide a pleasing feel and appearance upon finishing. For example, as shown in FIG. 3, the walls (30) of each baking well may meet the top surface (5) of the mold at a 90° top edge (6). This sharp top edge provides an appealing, recognizable bacon shape in the finished product. In some embodiments, the walls (30) of each baking well meet the floor (15) of the baking well at a rounded inner edge (16). This rounded inner edge helps to release the partially cooked product from the mold upon finishing and simplifies the cleaning of the mold for re-use. The walls (30) and/or floor (15) of the wells may have further indentations (e.g., wells within a well) or raised features, or a combination thereof, such that the interior surface of the well is textured to resemble naturally occurring meat tissues.

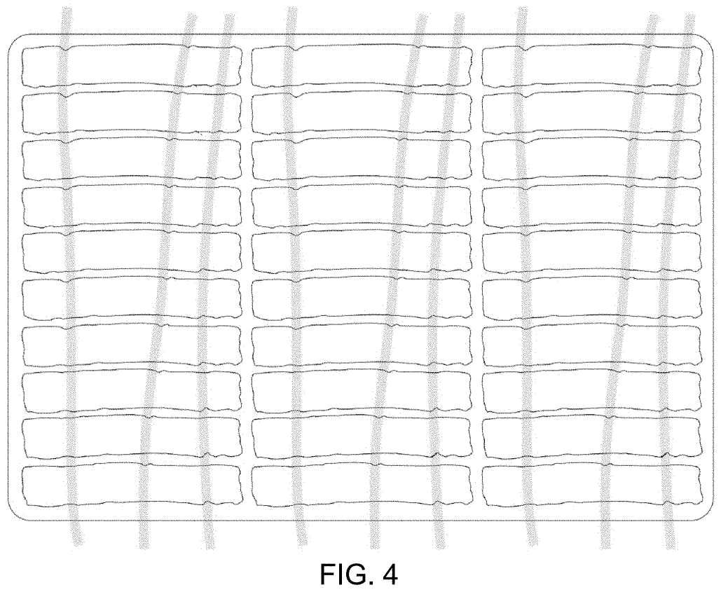

The shaped features (25) present in the periphery (20) may contain various combinations of notches, arcs, curves, rounded edges, and the like so as to resemble natural features in cut meat. The features may be convex feature that extend outward with respect to the floor of the baking well, or the features may be concave features that extend inward with respect to the floor of the baking well. The features may be aligned so as to resemble the natural features of a porky belly that once cut would produce such a shape variation in the bacon strips. Similar features in adjacent baking wells may be offset and distributed along the length of the wells, so as to resemble the natural shape progressions present from slice to slice made from a single cut of meat (e.g., pork belly) in the preparation of traditional products (e.g., pork bacon). This offsetting is depicted, for example, in FIG. 4 where the lines drawn across the top surface of the mold illustrate the natural shape progression mimicking genuine pork belly.

Accordingly, methods in some embodiments employ molds wherein the shaped features comprise a first convex feature in the periphery of a first baking well, a second convex feature in the periphery of a second baking well, a third convex feature in the periphery of a third baking well, and a fourth convex feature in the periphery of a fourth baking well,
wherein the shape of the first convex feature, the second convex feature, the third convex feature, and the fourth convex feature are substantially similar,
and wherein the position of the first convex feature, the second convex feature, the third convex feature, and the fourth convex feature are offset with respect to each other. In some embodiments, the position of the first convex feature, the second convex feature, the third convex feature, and the fourth convex feature are distributed along the length of the baking wells or the width of the baking wells to resemble a contour in a cut of meat.

In some embodiments, the shaped features further comprise a first concave feature in the periphery of the first baking well, a second concave feature in the periphery of the second baking well, a third concave feature in the periphery of the third baking well, and a fourth concave feature in the periphery of the fourth baking well,
wherein the shape of the first concave feature, the second concave feature, the third concave feature, and the fourth concave feature are substantially similar,
and wherein the position of the first concave feature, the second concave feature, the third concave feature, and the fourth concave feature are offset with respect to each other. In some embodiments, the position of the first concave feature, the second concave feature, the third concave feature, and the fourth concave feature are distributed along the length of the baking wells or the width of the baking wells to resemble a contour in a cut of meat.

In some embodiments, the distance between the first convex feature and the first concave feature in the first periphery, the distance between the second convex feature and the second concave feature in the second periphery, the distance between the third convex feature and the third concave feature in the third periphery, and the distance between the fourth convex feature and the fourth concave feature in the fourth periphery are substantially equal. Alternatively, the distance between given features in the peripheries of adjacent wells may increase or decrease linearly from a first well, to a second well, and to a third well, and so on. Shaped features can be positioned along peripheries having various geometries (e.g., a round periphery intended to resemble a pork belly cut such as pancetta). Positioning of the shaped features in this manner provides a finished product wherein individual slices of the plant-based product mimic the natural shape progression of the corresponding meat-based food.

### Compositions for Preparation of Plant-Based Food Products

In general, the plant-based products provided herein are vegetarian and are substantially free of meat and/or meat byproducts. In some embodiments, the plant-based products are vegan and substantially free of all animal-derived ingredients including, but not limited to, meats, eggs, and dairy products. In some embodiments, the plant-based meat replacement food product is a vegan bacon.

A number of flours are suitable for use in the methods and products provided herein. Examples of flours in the mixtures (e.g., the first mixture and/or the second mixture, as well as additional mixtures) include, but are not limited to, rice flour, chickpea flour, wheat flour, soy flour, mung bean flour, sesame flour, almond flour, coconut flour, hazelnut flour, quinoa flour, sorghum flour, corn flour, amaranth flour, teff flour, potato flour, millet flour, and combinations thereof. Depending on the dietary requirements of the intended consumers, flours tending to exhibit increased allergenicity (e.g., wheat flours, soy flours, or the like) may be excluded from the mixtures. In some embodiments, the flour in the first mixture and/or the second mixture contains rice flour. In some embodiments, the flour in the first mixture and the second mixture consists of rice flour. In some embodiments, the flour in the third mixture contains rice flour. In some embodiments, the flour in the third mixture consists of rice flour.

Similarly, various starches and oils may be employed. Examples of starches in the first mixture and/or the second mixture include, but are not limited to, tapioca starch, pea starch, cornstarch, arrowroot starch, potato starch, or combinations thereof. In some embodiments, the starch in the first mixture and/or the second mixture contains tapioca starch. In some embodiments, the starch in the first mixture and the second mixture consists of tapioca starch. Examples of oils in the first mixture and/or the second mixture include, but are not limited to, coconut oil, palm oil, palm kernel oil, cocoa butter, shea butter, kokum butter, illipe butter, sunflower oil, canola oil, rapeseed oil, or combinations thereof. In some embodiments, the oil in the first mixture and/or the second mixture contains coconut oil. In some embodiments, the oil in the first mixture and the second mixture consists of coconut oil. In some embodiments, the oil in the third mixture contains coconut oil. In some embodiments, the oil in the third mixture consists of coconut oil.

The amounts of flour, starch, and oil may be varied to achieve a texture that mimics the organoleptic properties of a particular meat-based food, including textural properties such as crunchiness, crispiness, and chewiness. Neutral-flavored flours, starches, and oils may be employed so as not to interfere with the taste of flavoring agents used in the preparation. Alternatively, amounts of flour, starch, and oil may be varied to increase or decrease the taste imparted by those components having stronger flavors. The amount of flour present in the first mixture and/or the second mixture, and further mixtures (e.g., a third mixture) when present, generally ranges from about 1% w/w to about 75% w/w, based on the total weight of the mixture. The flour may be present, for example, in an amount ranging from about 10% w/w to about 30% w/w, or from about 15% w/w to about 25% w/w, or from about 18% w/w to about 22% w/w. In some embodiments, the flour (e.g., rice flour) is present in the first mixture and the second mixture in an amount around 17-20% w/w, based on the total weight of the mixture. In some embodiments, the flour is present in the third mixture in an amount around 17-20% w/w, based on the total weight of the mixture.

The amount of starch present in the first mixture and/or the second mixture, and further mixtures (e.g., a third mixture) when present, generally ranges from about 0.5% w/w to about 50% w/w, based on the total weight of the mixture. The starch may be present, for example, in an amount ranging from about 5% w/w to about 25% w/w, or from about 10% w/w to about 20% w/w, or from about 12% w/w to about 16% w/w. In some embodiments, the starch (e.g., tapioca starch) is present in the first mixture and the second mixture in an amount around 13-15% w/w, based on the total weight of the mixture. In some embodiments, the starch is present in the third mixture in an amount around 13-15% w/w, based on the total weight of the mixture.

The amount of oil present in the first mixture and/or the second mixture, and further mixtures (e.g., a third mixture) when present, generally ranges from about 1% w/w to about 80% w/w, based on the total weight of the mixture. The oil may be present, for example, in an amount ranging from about 10% w/w to about 30% w/w, or from about 15% w/w to about 25% w/w, or from about 20% w/w to about 25% w/w. In some embodiments, the oil (e.g., coconut oil) is present in the first mixture and the second mixture in an amount around 20, 21, 22, 23, 24, or 25% w/w, based on the total weight of the mixture. In some embodiments, the oil is present in the third mixture in an amount around 20, 21, 22, 23, 24, or 25% w/w, based on the total weight of the mixture.

Water and optional flavoring agents typically account for the remaining mass of the first mixture and the second mixture and further mixtures (e.g., a third mixture) when present, although additional components (e.g., preservatives, viscosity modifiers, nutritive ingredients, or the like) may be present in minor amounts. The amount of water present in the mixtures generally ranges from about 10% w/w to about 90% w/w, based on the total weight of the mixture. The water may be present, for example, in an amount ranging from about 20% w/w to about 60% w/w, or from about 30% w/w to about 50% w/w, or from about 35% w/w to about 45% w/w. In some embodiments, the water is present in the first mixture and the second mixture in an amount around 40% w/w, based on the total weight of the mixture. In some embodiments, the water is present in the third mixture in an amount around 40% w/w, based on the total weight of the mixture. The amount of water may be varied to adjust the handling properties of the mixtures during preparation of the plant-based food product, or the extent to which a particular mixture will mix with other mixtures upon combination in baking wells and subsequent processing steps.

As described in more detail below, a batch containing flour, starch, oil, and water may be prepared and divided for coloring such that a first mixture is free of coloring agent, as in the original batch, while a second mixture contains a coloring agent. Uncolored mixtures generally take on color ranging from white to light brown or gold, resembling fat portions of meat. Colored mixtures may be varied to resemble the lean portions of meat. The coloring agent can be selected to resemble a naturally-occurring meat tissue (e.g., fat tissue, lean tissue, or skin tissue) in raw form or in cooked form. In some embodiments, the second mixture and further mixtures (e.g., a third mixture), when present further comprises or one or more coloring agents. Examples of coloring agents include, but are not limited to, beet juice concentrate, beetroot powder, radish powder, cabbage powder, annatto extract, purple potato powder, paprika oleoresin, β-carotene, and caramelized sugar. While natural coloring agents are preferred in many embodiments, synthetic coloring agents such as Red No. 40 (Allura Red) and E155 (Brown HT) may be employed when acceptable to intended consumers. In some embodiments, multiple mixtures (e.g., the first mixture and second mixture; or the second mixture and a further third mixture and/or fourth mixture) contain one or more coloring agents.

### Preparation of Plant-Based Food Products

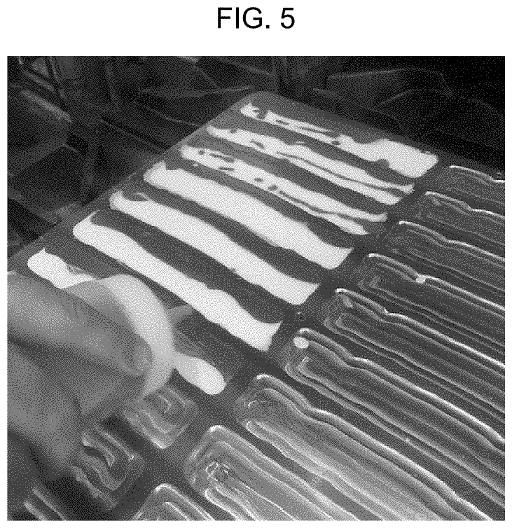

Mixtures prepared according to the methods described above are combined in baking wells to resemble the organic appearance of natural meats. An appetizing marbled appearance may be obtained, for example, by combining less colored or uncolored mixtures resembling fat with highly colored mixtures resembling lean. Accordingly, methods in some embodiments include alternating portions of the first mixture and the second mixture (and additional third, fourth, and fifth mixtures, etc.) in the mold to resemble fat regions and lean regions in meat. Portions may be alternated as stripes, swirls, whorls, waves, dots, patches, or the like so as to mimic natural tissues. As shown in FIG. 5, for example, the combination may be conducted manually. Filling of the molds may be mechanized (e.g., with a piston filler/depositor and/or a chain conveyor and/or like devices) for increased processing throughput.

Following combination of the mixtures in the baking molds, the mixtures are partially cooked so as to set the shape of the food product for unmolding and packaging. Partial cooking (par-cooking) during manufacture allows for a final cooking, e.g., in a home kitchen or restaurant kitchen, prior to direct consumption or use in other foods, e.g., a sandwich, pasta, or salad. In some embodiments, par-cooking the first mixture and the second mixture in the mold comprises baking at a temperature ranging from about 75° F. to about 500° F. Baking may be conducted, for example, at temperatures ranging from 100° F. to about 400° F., from about 200° F. to about 400° F., or from about 250° F. to about 350° F. In some embodiments, the baking is conducted at a temperature around 300° F. or 350° F. The baking may conducted for varying lengths of time, depending on the desired consistency of the par-cooked product. In some embodiments, the baking is conducted for a maximum of 30 minutes (e.g., less than 20 minutes, or less than 15 minutes, or less than 10 minutes). In some embodiments, the baking is conducted for around 15 minutes. Reduction of the water content during par-cooking provides products that are suitably rigid for packaging, storage, and further cooking prior to consumption. Typically, par-cooking will be conducted at a sufficient temperature and for sufficient time to reduce water content and the combined weight of weight of the first mixture and the second mixture by at least 5% w/w. In some embodiments, the weight of the plant-based meat replacement food product after par-cooking is 75-85% of the combined weight of the first mixture and the second mixture prior to par-cooking.

Flavoring agents are added to provide tastes associated with traditional meat-products. Flavoring agents may be added, for example, to provide the par-cooked products with tastes such as smoky, salty grassy, buttery, nutty, sweet, brothy, umami, juicy, browned, fatty, gamey, and bitter, in various combinations and to various degrees. Examples of flavoring agents suitable for preparation of the plant-based food products include, but are not limited to, salt, liquid smoke, mushrooms, mushroom extract, miso and other fermented soy products, seaweeds, tea, yeast extracts and hydrolysates, sugar, maple syrup, stevia, and carob. Chemical compounds (e.g., glutamate, inosinate, guanylate) giving rise to a desired flavor note (e.g., umami) may also be added. Flavorings may be adjusted according to preference, dietary needs, or other factors such as availability. Soy products may be omitted, for example, so as to avoid potential allergic reactions if necessary. Chemical additives may be omitted when an all-natural food product is desired. In some embodiments, the first mixture and the second mixture, and additional mixtures (e.g., a third mixture), if present, further comprise one or more flavoring agents, incorporated prior to par-cooking. The amount of flavoring agent(s) may range, for example, from about 1% to about 10% w/w based on the total mass of the mixture (e.g., 1-5%, or 5-10%, or 2-8%, or 6-8%).

In alternative embodiments, the methods further include applying one or more flavoring agents to the plant-based meat replacement food product (e.g., via soaking, painting, spraying, dusting, or other means). Additional coloring agents, preservatives, viscosity modifiers, nutritive ingredients, or other minor components may be applied in similar fashion prior to packaging of the plant-based food product (e.g., in a pouch, envelope, tray, or other suitable container).

### II. EXAMPLES

### Example 1. Preparation of Base Emulsion and Flavoring for Vegan Bacon Product

A base emulsion was prepared by combining rice flour, tapioca starch, and coconut oil in the amounts set forth in Table 1 and mixing. Once a loose gel was formed, water was slowly added to obtain a fully combined, liquefied mixture resembling wet paint or pancake batter. The mixture was held at 80-110° F. for to provide improved viscosity without cooking. The resulting emulsion was used as a white base for coloring with beet juice concentrate. The beet juice concentrate (0.1 kg) was added to one third of the white base to obtain a red base. The white base and red base were used for preparation of the finished vegan bacon product as described below.

TABLE 1
Base emulsion formula.

| Component | Mass (kg) | Ratio (% w/w) |
|---|---|---|
| Rice Flour | 3.9 | 21% |
| Tapioca Starch | 2.7 | 14.60% |
| Coconut Oil | 4.3 | 23.70% |
| Water | 11 | 40.20% |
| Beet Concentrate | 0.1 | |
| (mix with one third | | |
| of finished | | |
| emulsion) | | |

### Example 2. Molding and Finishing of Vegan Bacon Product

The white base and red base were combined in baking wells of a bacon-shaped mold as described above. White portions and red portions were alternated to resemble the fat and lean portions of pork bacon. Further portions with varying amounts of beet coloring were added to the combined mixture in selected areas of the baking wells to enhance the marbling effect. The filled wells were partially baked at 300-350° F. until the amount of water was reduced by about 20% of the total batch weight.

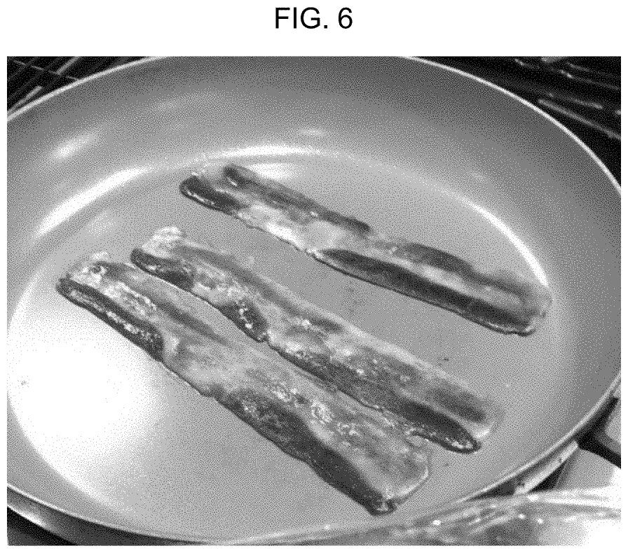

The partially baked strips were allowed to cool slightly, prior to application of flavoring to the warm strips. The strips were allowed to dry for 5-10 minutes and packaged in pouches or sheets of 10 strips each. Further cooking, e.g., on a stovetop in a home or restaurant setting as illustrated in FIG. 6, provides a fully cooked vegan bacon product.

### Example 3. Preparation of Vegan Bacon Product

Emulsions containing flavoring ingredients and varying amounts of beet juice concentrate, as shown in Table 2, were prepared as described in Example 1. The emulsions were combined in baking wells of bacon-shaped molds and partially baked as described in Example 2 prior to packaging. Further cooking provides a fully cooked vegan bacon product.

TABLE 2
Emulsion formulas.

| | White | Red | Pink |
|---|---|---|---|
| | Amount | Amount | Amount |
| Component | (% w/w) | (% w/w) | (% w/w) |
| Rice Flour | 17.88 | 17.45 | 17.84 |
| Tapioca Starch | 13.28 | 12.97 | 13.25 |
| Coconut Oil | 21.97 | 21.44 | 21.92 |
| Flavoring | 6.96 | 6.80 | 6.95 |
| Beet Concentrate | 0.00 | 2.39 | 0.24 |
| Water | qs to 100 | qs to 100 | qs to 100 |

### III. EXEMPLARY EMBODIMENTS

Exemplary embodiments provided in accordance with the presently disclosed subject matter include, but are not limited to, the claims and the following embodiments:
1. A method for preparing a plant-based meat replacement food product, the method comprising:
forming a first mixture comprising a flour, a starch, an oil, and water;
forming a second mixture comprising a flour, a starch, an oil, water, and a coloring agent;
combining the first mixture and the second mixture in a mold; and
par-cooking the first mixture and the second mixture in the mold, thereby forming the plant-based meat replacement food product.
2. The method of embodiment 1, wherein the plant-based meat replacement food product is a vegan bacon.
3. The method of embodiment 1 or embodiment 2, wherein the mold is a bacon-shaped mold or a pork belly-shaped mold.
4. The method of any one of embodiments 1-3, wherein the mold comprises:
a top surface comprising a plurality of baking wells,
wherein each baking well comprises:
a floor having a periphery comprising a plurality of shaped features, and
walls extending from the top surface of the mold to the floor of the baking well, wherein the walls meet the floor along the periphery of the floor; and
a bottom surface.
5. The method of embodiment 4, wherein each of the plurality of baking wells has a bacon strip shape.
6. The method of embodiment 4 or embodiment 5, where each of the plurality of baking wells is shaped differently from the other baking wells.
7. The method of any one of embodiments 4-6, wherein the average length of each baking well ranges from about two times the average width of the baking well to about ten time the average width of the baking well.
8. The method of any one of embodiments 4-7, wherein the depth of the baking well ranges from 0.025 times the average width of the baking well to about 0.25 times the average width of the baking well.
9. The method of any one of embodiments 4-8, wherein the walls of each baking well meet the top surface of the mold at a 90° top edge.
10. The method of any one of embodiments 4-9, wherein the walls of each baking well meet the floor of the baking well at a rounded inner edge.
11. The method of any one of embodiments 4-10, wherein the depth of each baking well ranges from 0.25 times the thickness of the mold to about 0.75 times the thickness of the mold.
12. The method of any one of embodiments 4-11, wherein the shaped features comprise a first convex feature in the periphery of a first baking well, a second convex feature in the periphery of a second baking well, a third convex feature in the periphery of a third baking well, and a fourth convex feature in the periphery of a fourth baking well,
wherein the shape of the first convex feature, the second convex feature, the third convex feature, and the fourth convex feature are substantially similar,
and wherein the position of the first convex feature, the second convex feature, the third convex feature, and the fourth convex feature are offset with respect to each other.
13. The method of embodiment 12, wherein the position of the first convex feature, the second convex feature, the third convex feature, and the fourth convex feature are distributed along the length of the baking wells or the width of the baking wells to resemble a contour in a cut of meat.
14. The method of embodiment 12 or embodiment 13, wherein the shaped features further comprise a first concave feature in the periphery of the first baking well, a second concave feature in the periphery of the second baking well, a third concave feature in the periphery of the third baking well, and a fourth concave feature in the periphery of the fourth baking well,
wherein the shape of the first concave feature, the second concave feature, the third concave feature, and the fourth concave feature are substantially similar,
and wherein the position of the first concave feature, the second concave feature, the third concave feature, and the fourth concave feature are offset with respect to each other.
15. The method of embodiment 14, wherein the position of the first concave feature, the second concave feature, the third concave feature, and the fourth concave feature are distributed along the length of the baking wells or the width of the baking wells to resemble a contour in a cut of meat.
16. The method of embodiment 14, wherein the distance between the first convex feature and the first concave feature in the first periphery, the distance between the second convex feature and the second concave feature in the second periphery, the distance between the third convex feature and the third concave feature in the third periphery, and the distance between the fourth convex feature and the fourth concave feature in the fourth periphery are substantially equal.
17. The method of any one of embodiments 1-16, wherein the first mixture further comprises one or more coloring agents.
18. The method of any one of embodiments 1-17, wherein combining the first mixture and the second mixture in the mold comprises alternating portions of the first mixture and the second mixture in the mold to resemble fat regions and lean regions in meat.
19. The method of claim 1, further comprising forming a third mixture comprising a flour, a starch, an oil, and water, and combining the third mixture with the first mixture and the second mixture in the mold.
20. The method of claim 19, wherein the third mixture further comprises a coloring agent.
21. The method of any one of embodiments 1-20, wherein the flour in the first mixture and/or the second mixture and/or the third mixture comprises rice flour, chickpea flour, wheat flour, soy flour, mung bean flour, sesame flour, almond flour, coconut flour, hazelnut flour, quinoa flour, sorghum flour, corn flour, amaranth flour, teff flour, potato flour, millet flour, or combinations thereof.
22. The method of embodiment 21, wherein the flour in the first mixture and/or the second mixture and/or the third mixture comprises rice flour.
23. The method of any one of embodiments 1-22, wherein the starch in the first mixture and/or the second mixture and/or the third mixture comprises tapioca starch, pea starch, cornstarch, arrowroot starch, potato starch, or combinations thereof.
24. The method of embodiment 23, wherein the starch in the first mixture and/or the second mixture and/or the third mixture comprises tapioca starch.
25. The method of any one of embodiments 1-24, wherein the oil in the first mixture and/or the second mixture and/or the third mixture comprises coconut oil, palm oil, palm kernel oil, cocoa butter, shea butter, kokum butter, illipe butter, sunflower oil, canola oil, rapeseed oil, or combinations thereof
26. The method of embodiment 25, wherein the oil in the first mixture and/or the second mixture and/or the third mixture comprises coconut oil.
27. The method of any one embodiments 1-26, wherein the flour is present in the first mixture and/or the second mixture and/or the third mixture in an amount ranging from about 15% w/w to about 25% w/w, based on the total weight of the mixture.
28. The method of any one embodiments 1-27, wherein the starch is present in the first mixture and/or the second mixture and/or the third mixture in an amount ranging from about 10% w/w to about 20% w/w, based on the total weight of the mixture.
29. The method of any one embodiments 1-28, wherein the oil is present in the first mixture and/or the second mixture and/or the third mixture in an amount ranging from about 15% w/w to about 25% w/w, based on the total weight of the mixture.
30. The method of any one embodiments 1-29, wherein the water is present in the first mixture and/or the second mixture and/or the third mixture in an amount ranging from about 35% w/w to about 45% w/w, based on the total weight of the mixture.
31. The method of any one embodiments 1-30, wherein par-cooking the first mixture and the second mixture and optionally the third mixture in the mold comprises baking at a temperature ranging from about 200° F. to about 400° F.
32. The method of any one embodiments 1-31, wherein the weight of the plant-based meat replacement food product is 75-85% of the combined weight of the first mixture and the second mixture and the optional third mixture.
33. The method of any one of embodiments 1-32, wherein the first mixture and the second mixture further and the optional third mixture comprise one or more flavoring agents.
34. The method of any one of embodiments 1-32, further comprising applying one or more flavoring agents to the plant-based meat replacement food product.
35. A plant-based meat replacement food product prepared according to the method of any one of the preceding embodiments.
36. A mold for a vegan bacon product comprising:
a top surface comprising a plurality of baking wells,
wherein each baking well comprises:
a floor having a periphery comprising a plurality of shaped features, and
walls extending from the top surface of the mold to the floor of the baking well, wherein the walls meet the floor along the periphery of the floor; and
a bottom surface.
37. The mold of embodiment 36, wherein each of the plurality of baking wells has a bacon strip shape.
38. The mold of embodiment 36 or embodiment 37, where each of the plurality of baking wells is shaped differently from the other baking wells.
39. The mold of any one of embodiments 36-38, wherein the average length of each baking well ranges from about two times the average width of the baking well to about ten time the average width of the baking well.
40. The mold of any one of embodiments 36-39, wherein the depth of the baking well ranges from 0.025 times the average width of the baking well to about 0.25 times the average width of the baking well.
41. The mold of any one of embodiments 36-40, wherein the walls of each baking well meet the top surface of the mold at a 90° top edge.
42. The mold of any one of embodiments 36-41, wherein the walls of each baking well meet the floor of the baking well at a rounded inner edge.
43. The mold of any one of embodiments 36-42, wherein the depth of each baking well ranges from 0.25 times the thickness of the mold to about 0.75 times the thickness of the mold.
44. The mold of any one of embodiments 36-43, wherein the shaped features comprise a first convex feature in the periphery of a first baking well, a second convex feature in the periphery of a second baking well, a third convex feature in the periphery of a third baking well, and a fourth convex feature in the periphery of a fourth baking well,
wherein the shape of the first convex feature, the second convex feature, the third convex feature, and the fourth convex feature are substantially similar,
and wherein the position of the first convex feature, the second convex feature, the third convex feature, and the fourth convex feature are offset with respect to each other.
45. The mold of embodiment 44, wherein the position of the first convex feature, the second convex feature, the third convex feature, and the fourth convex feature are distributed along the length of the baking wells or the width of the baking wells to resemble a contour in a cut of meat
46. The mold of embodiment 44 or embodiment 45, wherein the shaped features further comprise a first concave feature in the periphery of the first baking well, a second concave feature in the periphery of the second baking well, a third concave feature in the periphery of the third baking well, and a fourth concave feature in the periphery of the fourth baking well,
wherein the shape of the first concave feature, the second concave feature, the third concave feature, and the fourth concave feature are substantially similar,
and wherein the position of the first concave feature, the second concave feature, the third concave feature, and the fourth concave feature are offset with respect to each other.
47. The mold of embodiment 46, wherein the position of the first concave feature, the second concave feature, the third concave feature, and the fourth concave feature are distributed along the length of the baking wells or the width of the baking wells to resemble a contour in a cut of meat.
48. The mold of embodiment 46, wherein the distance between the first convex feature and the first concave feature in the first periphery, the distance between the second convex feature and the second concave feature in the second periphery, the distance between the third convex feature and the third concave feature in the third periphery, and the distance between the fourth convex feature and the fourth concave feature in the fourth periphery are substantially equal.

Although the foregoing has been described in some detail by way of illustration and example for purposes of clarity and understanding, one of skill in the art will appreciate that certain changes and modifications can be practiced within the scope of the appended claims. In addition, each reference provided herein is incorporated by reference in its entirety to the same extent as if each reference was individually incorporated by reference.

1. A method for preparing a plant-based meat replacement food product, the method comprising:
forming a first mixture comprising a flour, a starch, an oil, and water;
forming a second mixture comprising a flour, a starch, an oil, water, and a coloring agent;
combining the first mixture and the second mixture in a mold; and
par-cooking the first mixture and the second mixture in the mold, thereby forming the plant-based meat replacement food product.

2. The method of claim 1, wherein the plant-based meat replacement food product is a vegan bacon.

3. (canceled)

4. The method of claim 1, wherein the mold comprises:
a top surface comprising a plurality of baking wells,
wherein each baking well comprises:
a floor having a periphery comprising a plurality of shaped features, and
walls extending from the top surface of the mold to the floor of the baking well, wherein the walls meet the floor along the periphery of the floor; and
a bottom surface.

5-6. (canceled)

7. The method of claim 4, wherein:
the average length of each baking well ranges from about two times the average width of the baking well to about ten time the average width of the baking well; and/or
the depth of the baking well ranges from 0.025 times the average width of the baking well to about 0.25 times the average width of the baking well; and/or
the walls of each baking well meet the top surface of the mold at a 90° top edge; and/or
the walls of each baking well meet the floor of the baking well at a rounded inner edge; and/or
the depth of each baking well ranges from 0.25 times the thickness of the mold to about 0.75 times the thickness of the mold.

8-11. (canceled)

12. The method of claim 4, wherein the shaped features comprise a first convex feature in the periphery of a first baking well, a second convex feature in the periphery of a second baking well, a third convex feature in the periphery of a third baking well, and a fourth convex feature in the periphery of a fourth baking well,
wherein the shape of the first convex feature, the second convex feature, the third convex feature, and the fourth convex feature are substantially similar,
and wherein the position of the first convex feature, the second convex feature, the third convex feature, and the fourth convex feature are offset with respect to each other.

13. The method of claim 12, wherein the position of the first convex feature, the second convex feature, the third convex feature, and the fourth convex feature are distributed along the length of the baking wells or the width of the baking wells to resemble a contour in a cut of meat.

14-16. (canceled)

17. The method of claim 1, wherein the first mixture further comprises one or more coloring agents.

18. The method of claim 1, wherein combining the first mixture and the second mixture in the mold comprises alternating portions of the first mixture and the second mixture in the mold to resemble fat regions and lean regions in meat.

19-20. (canceled)

21. The method of claim 1, wherein the flour in the first mixture and/or the second mixture comprises rice flour, chickpea flour, wheat flour, soy flour, mung bean flour, sesame flour, almond flour, coconut flour, hazelnut flour, quinoa flour, sorghum flour, corn flour, amaranth flour, teff flour, potato flour, millet flour, or combinations thereof.

22. (canceled)

23. The method of claim 1, wherein the starch in the first mixture and/or the second mixture comprises tapioca starch, pea starch, cornstarch, arrowroot starch, potato starch, or combinations thereof.

24. (canceled)

25. The method of claim 1, wherein the oil in the first mixture and/or the second mixture comprises coconut oil, palm oil, palm kernel oil, cocoa butter, shea butter, kokum butter, illipe butter, sunflower oil, canola oil, rapeseed oil, or combinations thereof.

26. (canceled)

27. The method of claim 1, wherein:
the flour is present in the first mixture and/or the second mixture in an amount ranging from about 15% w/w to about 25% w/w, based on the total weight of the mixture; and/or
the starch is present in the first mixture and/or the second mixture in an amount ranging from about 10% w/w to about 20% w/w, based on the total weight of the mixture; and/or
the oil is present in the first mixture and/or the second mixture in an amount ranging from about 15% w/w to about 25% w/w, based on the total weight of the mixture; and/or
the water is present in the first mixture and/or the second mixture in an amount ranging from about 35% w/w to about 45% w/w, based on the total weight of the mixture.

28-32. (canceled)

33. The method of claim 1, wherein the first mixture and the second mixture further comprise one or more flavoring agents, or wherein the method further comprises applying one or more flavoring agents to the plant-based meat replacement food product.

34. (canceled)

35. A plant-based meat replacement food product prepared according to the method of claim 1.

36. A mold for a vegan bacon product comprising:
a top surface comprising a plurality of baking wells,
wherein each baking well comprises:
a floor having a periphery comprising a plurality of shaped features, and
walls extending from the top surface of the mold to the floor of the baking well, wherein the walls meet the floor along the periphery of the floor; and
a bottom surface.

37. The mold of claim 36, wherein each of the plurality of baking wells has a bacon strip shape.

38. (canceled)

39. The mold of claim 36, wherein:
the average length of each baking well ranges from about two times the average width of the baking well to about ten time the average width of the baking well; and/or
the depth of the baking well ranges from 0.025 times the average width of the baking well to about 0.25 times the average width of the baking well; and/or
the walls of each baking well meet the top surface of the mold at a 90° top edge; and/or
the walls of each baking well meet the floor of the baking well at a rounded inner edge; and/or
the depth of each baking well ranges from 0.25 times the thickness of the mold to about 0.75 times the thickness of the mold.

40-43. (canceled)

44. The mold of claim 36, wherein the shaped features comprise a first convex feature in the periphery of a first baking well, a second convex feature in the periphery of a second baking well, a third convex feature in the periphery of a third baking well, and a fourth convex feature in the periphery of a fourth baking well,
wherein the shape of the first convex feature, the second convex feature, the third convex feature, and the fourth convex feature are substantially similar,
and wherein the position of the first convex feature, the second convex feature, the third convex feature, and the fourth convex feature are offset with respect to each other.

45. The mold of claim 44, wherein the position of the first convex feature, the second convex feature, the third convex feature, and the fourth convex feature are distributed along the length of the baking wells or the width of the baking wells to resemble a contour in a cut of meat.

46-47. (canceled)

48. The mold of claim 46, wherein the distance between the first convex feature and the first concave feature in the first periphery, the distance between the second convex feature and the second concave feature in the second periphery, the distance between the third convex feature and the third concave feature in the third periphery, and the distance between the fourth convex feature and the fourth concave feature in the fourth periphery are substantially equal.
